(19) United States
(12) Patent Application Publication
(10) Pub. No.: US 2015/0006413 A1
(43) Pub. Date: Jan. 1, 2015

(54) ADVISOR CERTIFICATION SYSTEM AND METHOD

(71) Applicant: Maritz Holdings Inc., Fenton, MO (US)

(72) Inventors: David Mulkey, Washington, MO (US); Joseph White, Pacific, MO (US); Jennifer Passini, St. Louis, MO (US)

(21) Appl. No.: 14/311,593

(22) Filed: Jun. 23, 2014

Related U.S. Application Data
(60) Provisional application No. 61/841,547, filed on Jul. 1, 2013.

(51) Int. Cl. G06Q 30/00

(52) U.S. Cl. CPC G06Q 30/018
USPC 705/317

(57) ABSTRACT

A system and processor executed method for implementing a certification program for individuals. A design module and interface define a certification program for individuals. An input module and interface receive qualitative and quantitative data for each individual. The received data corresponds to the defined certification program. An analytic module with rules of the defined certification program is applied to the received data to provide a qualitative analysis of the received qualitative data and to provide a quantitative analysis of the received quantitative data. Summarization and classification modules characterize and rank individuals based on the provided analysis. Selected individuals are certified based on their classification and ranking. A tangible, non-transitory storage medium having processor executable instructions for implementing a certification program for individuals is also provided.

### BACKGROUND

Investment firms and wealth management firms rely on their advisor network to meet the needs of their clients and to appropriately reflect the brand and image of the firms. Like many industries that rely on a channel of resources to interact with clients and provide products and services to customers, investment firms and wealth management firms leverage advisors to help build and retain the business. Because of the great importance of a solid and high performing advisor base, firms are looking for ways to attract, employ, and retain top performing advisors. Additionally, firms want to be able to identify advisors that may not be meeting the expectations to the firm.

Overall, these unit level customer satisfaction program are an invaluable tool to understand the impact of the channel network. For investment firms and wealth management firms, an advisor-focused customer satisfaction program provides detailed information about the impact of advisors on overall satisfaction with the firm and in the firms' ability to leverage the advisor network to build the business. This type of program is particularly important for organizations that do not have a captive channel or an independent broker or advisor network. Ultimately, top performing advisors that provide consistently positive customer experiences lead to desired business outcomes including:
More assets under management
Greater share of wallet
More referrals and recommendations from other clients

### SUMMARY

A system and process method for implementing a certification program for individuals. A design module and interface define a certification program for individuals. An input module and interface receive qualitative and quantitative data for each individual. The received data corresponds to the defined certification program. An analytic module with rules of the defined certification program applied to the received data to provide a qualitative analysis of the received qualitative data and to provide a quantitative analysis of the received quantitative data. A summarization and classification module characterizes and ranks individuals based on the provided analysis. Selected individuals are certified based on the classification and ranking

A tangible, non-transitory storage medium having processor executable instructions for implementing a certification program for individuals is also provided.

In one form, an advisor level program having a goal of exploring clients' satisfaction and loyalty levels of advisors is provided, which may also be based on experiences with the advisors. Such advisor level assessments can provide scores to:
Identify strengths and improvement opportunities at an advisor level
Isolate and define specific opportunities with individual clients to retain their business or deepening relationships
Provide input to coaching and training or to specific issues related to resource management
Determine compensation and incentives at an advisor level

In addition to these outcomes of advisor-focused program, results from this type of program can be used as a basis for certifying top performing advisors. The best firms have figured out how to best identify and leverage top performing advisors to help build and retain the business. An Advisor Certification Program can be mutually beneficial for both firms and advisors in terms of:
Gauging performance
Focusing on ways to improve service to clients and/or specific offering
Demonstrating commitment to clients

Ultimately, a certification formalizes the process of measuring advisor performance and rewarding top performers. In one form, such an Advisor Certification Program can be focused on advisors' customer-focus and service performance based on both quantitative and qualitative analysis.

### BRIEF DESCRIPTION OF THE DRAWINGS

FIG. 1 illustrates a block diagram of a system according to one embodiment for implementing the Advisor Certification Program.

FIG. 2 summarizes one embodiment of a process of the Advisor Certification Program.

FIG. 3 illustrates a block diagram of a system according to one embodiment for implementing the Advisor Certification Program.

FIG. 4 is a mock-up of a screen shot of a financial advisor dashboard.

FIG. 5 is a mock-up of a screen shot of an organization dashboard.

FIG. 6 is a mock-up of a screen shot of an opportunity summary for either a financial advisor or an organization.

FIGS. 7A-7D are mock-ups of screen shots of responsibility distribution.

Appendix A illustrates a mock-up of a screen shot of survey results of a particular client of his/her financial advisor.

Appendix B illustrates a mock-up of a screen shot of survey results of a plurality of clients of their financial advisor.

### DETAILED DESCRIPTION

For investment firms and wealth management firms, the “unit” assessed in these programs are the individual advisors, providing a comprehensive Certification Program. Such programs are designed to measure, assess, and evaluate advisors to determine if certification should be awarded. Certification can be based on one or more of the following:
High performance scores
Proven commitment to individual clients
Demonstrated commitment to continuous improvement

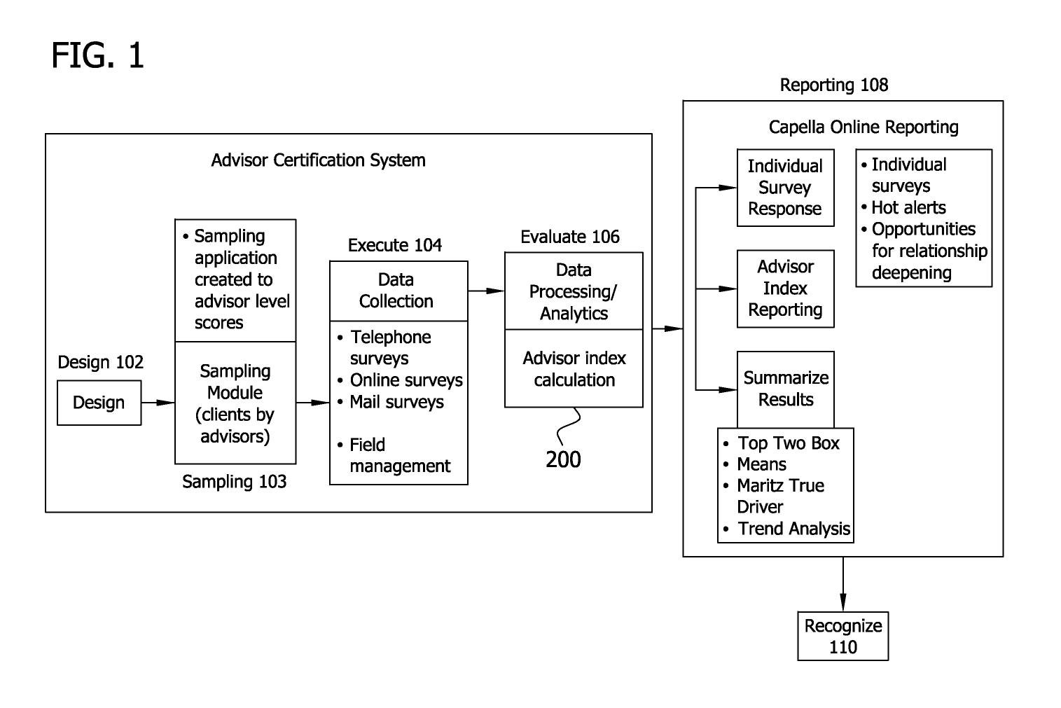

### FIG. 1

FIG. 1 illustrates a block diagram of a system according to one embodiment for implementing the Advisor Certification Program. In one form, the system includes the following in order to evaluate and determine advisor certification:

Design Module 102—While the overall aspects for a certification program are consistent from program to program, the design of each program can be customized to reflect specific needs and environment of the advisor network. Thus, the scope and focus of the program can be concentrated on allowing firms to better understand their organization and the advisor network.

Input Module—An input module and interface receives qualitative and quantitative data for each individual. The received data corresponds to the defined certification program. The input module comprises a sampling module 103 and a data collection module 104.

Sampling Module 103—The Program Implementer (which can be the firm or a third party) uses an interface of the design module 102 to create a sampling module implementing computer-executable instructions for a sampling plan to ensure that enough surveys are collected at an individual advisor level. The sampling plan will consider the population of clients by advisor and frequency of measurement. Census sampling is recommended to ensure that all clients are given an opportunity to provide feedback and to ensure enough surveys for each advisor are collected.

Execute (Data Collection) Module 104—The Program Implementer will design a customized Certification Program which will include two components—Quantitative Measurement and Qualitative Assessment. These two components combined provide the basis for determining whether advisors should receive certification or not.

Evaluate (Analytic) Module 106—An analytic module 106 with rules of the defined certification program applied to the received data to provide a qualitative analysis of the received qualitative data and to provide a quantitative analysis of the received quantitative data. The analytic module 106 includes a quantitative measurement module and a qualitative measurement module.

Quantitative Measurement Module—The Program Implementer conducts a client survey to explore their perceptions of and experiences with the firm and their assigned advisors. A survey design should generate sound and reliable scores for each individual advisor. The results of the survey are input into the system for analysis and comparison.

Qualitative Assessment—In addition to conducting a quantitative study to explore advisor performance, a qualitative assessment is conducted to determine advisors' commitment to customers' experiences and satisfaction levels and to continuously improving service levels based on identifying opportunities. To conduct this assessment, each advisor's operations is considered for the program, including an understanding of what steps advisors take to provide positive customer experiences and to ensure continuous improvement. The results of the assessment are input into the system for analysis and comparison.

The analytic module 106 uses the results from the Quantitative Measurement (scores) and Qualitative Assessment to evaluate whether or not advisors should receive certification. As part of the program, targets and expectations for which to evaluate advisor performance are defined. These evaluators will be defined during the Design step. In addition, an Advisor Certification Index (ACI) comprised of key outcome metrics is generated. For example, the ACI may be a weighted index comprising such outcome metrics as advisor trust, willingness to invest additional funds with the advisor, and likelihood to recommend the advisor to friends, family, or colleagues.

Reporting 108—Existing reporting systems can be used to house and distribute scores from the Quantitative Measurement and Qualitative Assessment. For example, the Capella™ system (see U.S. patent application Ser. No. 13/766,906 (9977.US), incorporated herein by reference) will provide results for various levels of the firm, but most importantly to advisors so that they will have access to their scores, certification status, and the ability to review results that comprise the scores.

Recognize 110—The system and method recognize advisors that are identified as top performers who demonstrate commitment to customers and to continuous improvement. This recognition will include certification, and may also include incentives and other compensation. Incentives and/or compensation are defined by the program based on firm input and are determined and paid out by the firm which employs/supplies the advisors. Those advisors that receive certification will be recognized both internally at their firm and externally with current and potential clients.

In one embodiment, the analytic module 106 includes an advisor index calculation module 200 for generating an advisor index calculation. In one form, the advisor index calculation module 200 includes software instructions for implementing the following formula for Advisor Index calculation:

$${α}_{j}^{*} = \frac{\frac{{n}_{j}}{{σ}_{y}^{2}} \cdot {\overline{y}}_{J} + \frac{1}{{σ}_{α}^{2}} \cdot \overline{{y}_{all}}}{\frac{{n}_{j}}{{σ}_{y}^{2}} + \frac{1}{{σ}_{α}^{2}}}$$

Where αⱼ* is the individual advisor score index for advisor j;
Where nⱼ is the number of valid index observations for advisor j;
Where σ_{y}² is the index variance at the advisor level;
Where y̅ⱼ is an unpooled weighted average for advisor j scores in trust and recommend;
   Where σ_{α}² is the variance in the average index across advisors; and
Where y̅ₐ̅ₗ̅ₗ̅ is an unpooled weighted average for all advisor scores in trust and recommend.

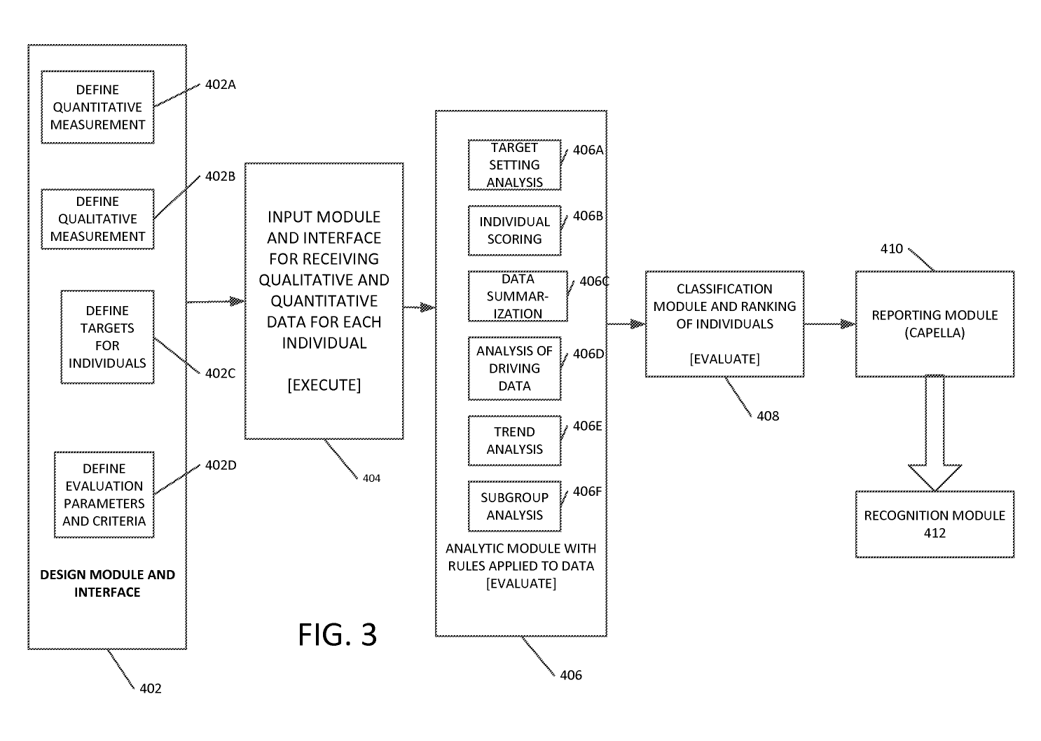

Also referred to as a summarization module 406C in FIG. 3, module 200 is configured to generate advisor scores based on the advisor index calculation. The summarization module leverages individual responses to the two to three questions within the quantitative survey to calculate the index. These scores may include Overall Advisor Satisfaction, Likelihood to Recommend Advisor, and responses to specific performance-related questions. Each score is based on the “trust” of the advisor by their clients and whether their clients would “recommend” the advisor.

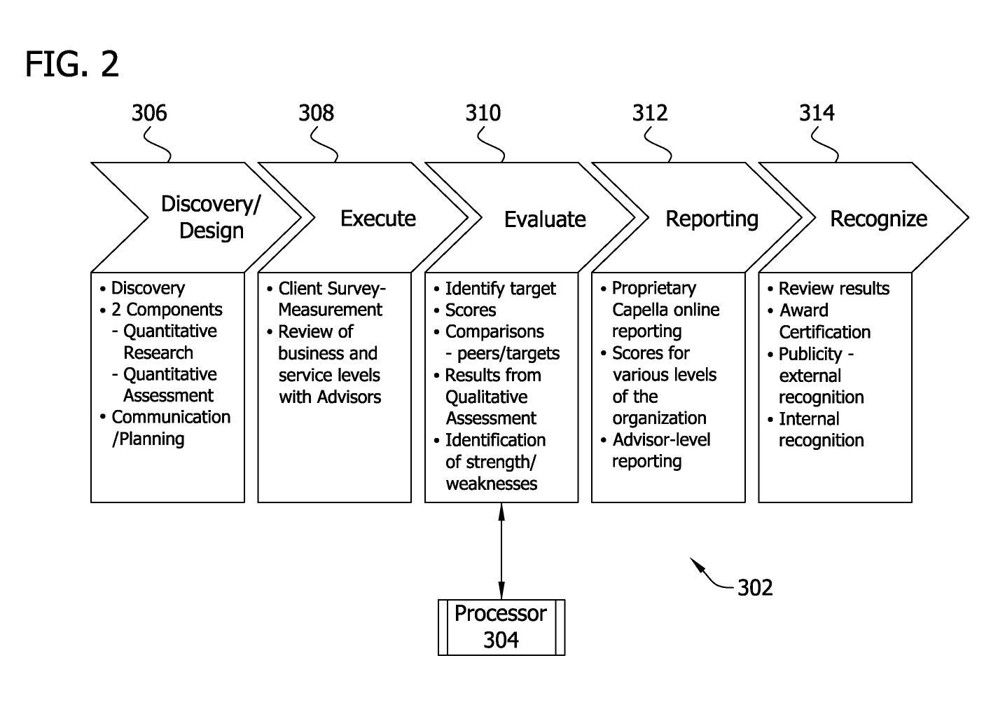

### FIG. 2

FIG. 2 summarizes one embodiment of a computerized process for implementing the Advisor Certification Program. In particular, the program can be implemented as computer executable instructions stored on a tangible, non-transitory storage medium 302 which is accessed by a processor 304 so that the processor 304 executes the instructions stored on the medium 302. The instructions include discovery/design instructions 306 which assist the program implementer in specifying the scope of the quantitative research which will be part of the program. The discovery/design instructions 306 also guide the program implementer to define a qualitative assessment of the program. The discovery/design instructions 306 also guide the program implementer to specify any communication or planning required as part of the program.

The instructions stored on the medium 302 also include execute instructions 308 which execute a client survey for measuring advisor performance. For example, the survey may be an on-line, email or other electronic communication soliciting client feedback regarding the client's advisor. An advisor survey may also be conducted. The execute instructions 308 collect and provide data for review of the business and service levels of advisors.

The instructions stored on the medium 302 also include evaluate instructions 310 which analyze the collected data to provide one or more of the following:
identify targets for an advisor;
score advisors;
compare advisors to their peers and compare advisor targets to peer targets;
compile and summarize the qualitative assessment data collected by the execute instructions; and
identify strengths and weaknesses of advisors.

The instructions stored on the medium 302 also include reporting instructions 312 which present the analysis from the evaluate instructions 310 to the program implementer, firm and advisors. The presentation may be in the form or a written report or an on-line user interface such as Capella™. The reporting includes scores for various levels of the firm as well as advisor-level reporting.

Optionally, the instructions stored on the medium 302 also include recognize instructions 314 which permit the program implementer, firm and advisors to review the results, award certifications, generate publicity or other external recognition, and generate internal recognition.

### FIG. 3

FIG. 3 illustrates a block diagram of a system according to one embodiment for implementing the Advisor Certification Program. In the next few sections, a summary of design elements and considerations for an Advisor Certification Program is provided. As previously mentioned, the approach is to develop a customized program based on the culture and advisor network of each firm. However, the same considerations are made regardless of the firm; only the translation may be different from firm to firm.

As illustrated in FIG. 3, a system for implementing a certification program for individuals is illustrated. The system includes a design module and interface 402 for defining a certification program for individuals. An input module and interface 404 receives qualitative and quantitative data for each individual. The received data corresponds to the defined certification program. An analytic module 406 with rules of the defined certification program is applied to the received data to provide an analysis of the received data. The system also includes a classification module 408 for classifying and ranking individuals based on the provided analysis. As a result, selected individuals are certified based on the classification and ranking

A reporting module 410 presents the classification and ranking of individuals and an optional a recognition module 410 awards certifications and generates recognition.

In one form, the design module and interface 402 includes:
A module 402A for defining quantitative measurement of each individual;
A module 402B for defining qualitative measurement of each individual;
A module 402C for defining targets each individual; and
A module 402D for defining evaluation parameters and criteria for each individual.

In one form, the analytic module 406 includes:
A target setting analysis module 406A for setting and evaluating a target for each individual;
An individual scoring module 406B for scoring each individual based on the target setting and/or based on the received qualitative or quantitative data;
A data summarization module 406C for summarizing the received data and/or summarizing the analysis;
An analysis module 406D for analyzing received data which drives the classification and ranking of the individuals;
A trend module 406E for identifying trends in the received data; and
A subgroup analysis module 406F for analyzing received data based on subgroups of the individuals.

In one form, each module comprises a processor and computer executable instructions stored on a memory device and executed by its processor for implementing the module, and/or each module comprises computer executable instructions stored on a memory device and one or more processors access each module for executing the instructions to implement the modules.

### Design Module and Interface 402

The purpose of Discovery is to collect enough information to design a customized Advisor Certification Program. A working session with key stakeholders at the firm (especially those who support, manage, or regularly interact with the advisor network) is recommended to explore expectations of advisors and what goals the firm hopes to achieve through the advisor network. More tactical aspects of the advisor network (i.e., how many, average tenure, size of client base) and any existing research conducted related to customers' experiences with their advisors or the firm should also be explored.

Based on this Discovery step, the Program Implementer will have information to support the design of a customized Advisor Certification Program based on the needs and scope of the firm. Following Discovery, the Program Implementer will make detailed recommendations of:
The scope of Quantitative Measurement 402A
The scope of Qualitative Assessment 402B
Ways to define targets 402C
Ways to evaluate advisors 402D

### Execute (Input Module 404)

Once the specifications of the program are set, the processor as directed by the Program Implementer designs and execute the next two components—Quantitative Measurement and Qualitative Assessment. These two steps of the programs can be conducted concurrently.

### Quantitative Measurement

The Quantitative Measurement step is a survey of clients that work with advisors. The objectives of this step are to gauge clients' perceptions and satisfaction levels with advisors and the firm and to understand advisors' performance levels. The results of the survey are input into the system for analysis and comparison.

### Research Design

In terms of research design, this Quantitative Measurement can have different shapes. This study can be conducted as a larger, one-time study or as an ongoing wave-based program. Some of our clients choose a wave-based program to collect feedback over time, but base scores on the all surveys collected annually.

### Sample and Quota Management

A census or representative sampling of clients for each advisor is recommended to ensure that enough responses are collected to serve as a solid basis for scores. At a minimum, 30 surveys per advisor should be collected. Availability of contact information will influence the methodology selected.

### Questionnaire

The questionnaire is part of this Quantitative Measurement step. The questionnaire should include the following topics. Areas that are particularly important to Advisor Certification are bolded.
Overall perceptions and satisfaction levels with the firm
Overall perceptions and satisfaction levels with the advisor
Likelihood to recommend firm or advisor
Interactions with advisors (reason for contact, frequency of contact, method of contact)
Perception of advisor interactions/performance
Problem incidence and resolution
   The results of the questionnaire are input into the system for analysis and comparison.

Based on our experience conducting financial advisor studies for clients in the investment services and wealth management sector, an Advisor Index is created for measuring, tracking, and comparing advisor performance. This Advisor Index, which is derived from questions within the survey, will one information source to determine whether certification can be awarded or not.

### Analytic Plan (Analytic Module 406)

The Program Implementer develops an analytic plan specific to this program and will include the following types of analyses:
Target setting analyses, including break-point analyses to define the most appropriate targets 406A
Scores by advisor (e.g., based on a recommended index) 406B
Data summarization of other results by advisor 406C
True Driver Analysis™ (TDA™)—conducted at a firm level 406D

Additional analyses may be conducted based on the needs and desires of the firm. Some other analyses that are recommended include:
Trend analyses, for ongoing tracking studies 406E
Subgroup comparisons, including customer segments and groups defined by other important data breaks, such as assets under management 406F

### Qualitative Assessment

While the Quantitative Measurement step is the source for determining advisor performance scores, the purpose of the Qualitative Assessment is to audit advisors' operations to ensure that client-focus and commitment to continuous improvement. As part of this assessment, the Program Implementer will visit each advisor to explore:
How well advisors meet the expectations of the firm
Approach to clients' in-person visits
Handling of clients' telephone calls
Communication with clients
Handling of problems/issues
Action plans in place to make improvements
How advisors leverage VOC (voice-of-customer)

The results of the assessment are input into the system for analysis and comparison.

This assessment will be based on:
Observations of client interactions
Observations of advisors with staff
In-depth interviews or focus groups with advisors and office staff

Following completion of the assessment, the Program Implementer will complete a checklist and will create a summary of the observations from the visit with advisors and office staff The checklist will be created based on firm requirements and expectations of advisors or based on best practices for providing positive customer experiences.

### Evaluate (Classification Module 408)

Based on results from the Quantitative Measurement and Qualitative Assessment steps, the Program Implementer will go through a process of evaluating advisors. Considerations:
Whether advisors' scores indicate high performance and meet or exceed targets
If advisors demonstrate strong commitment to customers and continuous improvement

The considerations for the factors for evaluating whether or not advisors should be certified will be defined as part of the Design phase. In particular, the Program Implementer will leverage our Advisor Certification Index (a composite of key measures, including satisfaction, loyalty, and share of wallet). The Program Implementer will develop an analytic module to generate this index based on a defined mathematical formula. The index and other scores from the Qualitative Measurement and Qualitative Assessment will be reported via an advisor-focus designed Capella reporting system.

### Reporting 410

Results from the Advisor Certification Program be reported and housed via our online reporting system, e.g., a Capella™ system or other reporting system. Preferably, such systems would report high-level and detailed results from the Quantitative Measurement and Qualitative Assessment steps. In addition, the reporting system will include tools that will encourage advisors to interpret results and develop action plans to make improvements based on identified opportunities.

Customer experience data should also be reported to highlight strengths and improvement opportunities. In addition, the reporting system could include tools for:
Following up with at risk customers and/or those reporting problems or issues
Creating performance plans for areas of advisor deficiencies
Developing action plans based on identified improvement opportunities

Through the reporting system, results at an advisor level and for other level of the advisor network (e.g., firm, regions, etc.) can be reported. Access to the data is customized based on users' level within the organization.

### Recognize 412

Recognizing top performing advisors in the following ways may be part of the program and is recommended:
Award certification—top performing advisors will be able to display indicator of certification
Internal recognition—advisors will be recognized among their peers through electronic communication (via e-mail and the firm website) and may be recognized during a firm event
External recognition—advisors will be able to communicate certification to current customers and prospects and can leverage certification in marketing and advertising plans

Additionally, some firms may decide to extend the certification program to include other types of rewards and recognition (which is considered part of the Enable phase). Other types of rewards programs include:
Compensation packages based on performance
Reward points
Reward cash/bonuses
   The above recognition can be implemented automatically by software instructions and/or by manual actions such as by supervisors or the Program Implementer.

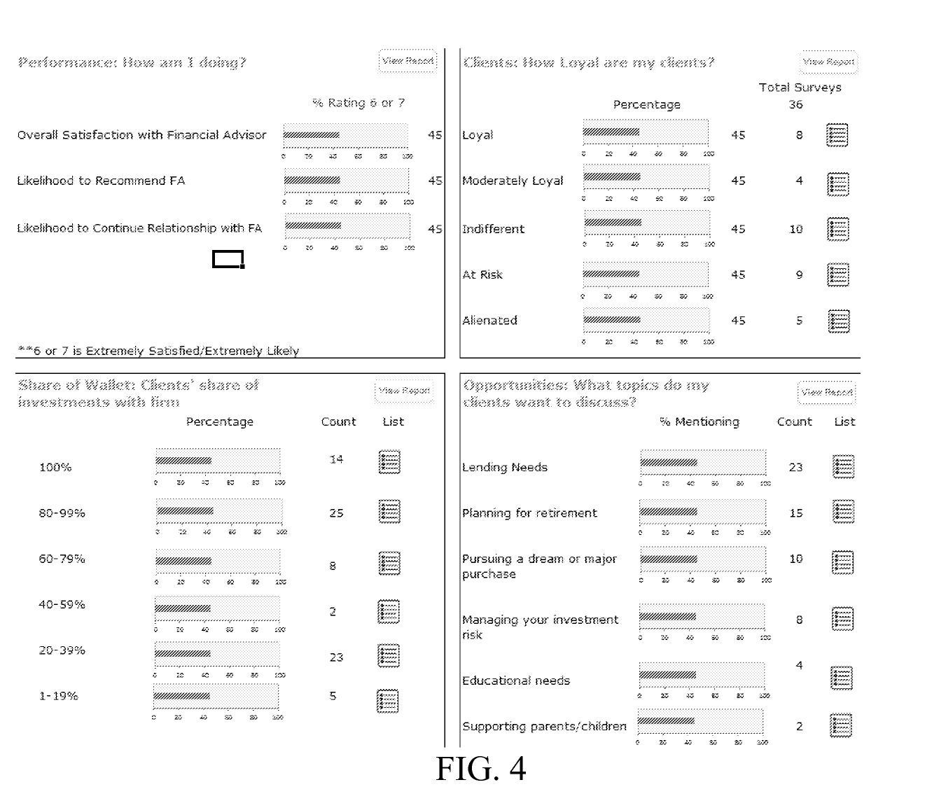

FIG. 4 is a mock-up of a screen shot of a financial advisor dashboard. In this form, the dashboard presents four quadrants to the financial advisor summarizing qualitative and quantitative data. The top left quadrant summarizes the quantitative data indicating how the financial advisor is doing. The top right quadrant summarizes the quantitative data indicating how loyal the financial advisor's clients are. The bottom left quadrant summarizes the qualitative data indicating the financial advisor's clients share of the investments within the organization. The bottom right quadrant summarizes the quantitative data indicating what topics the financial advisor's clients want to discuss.

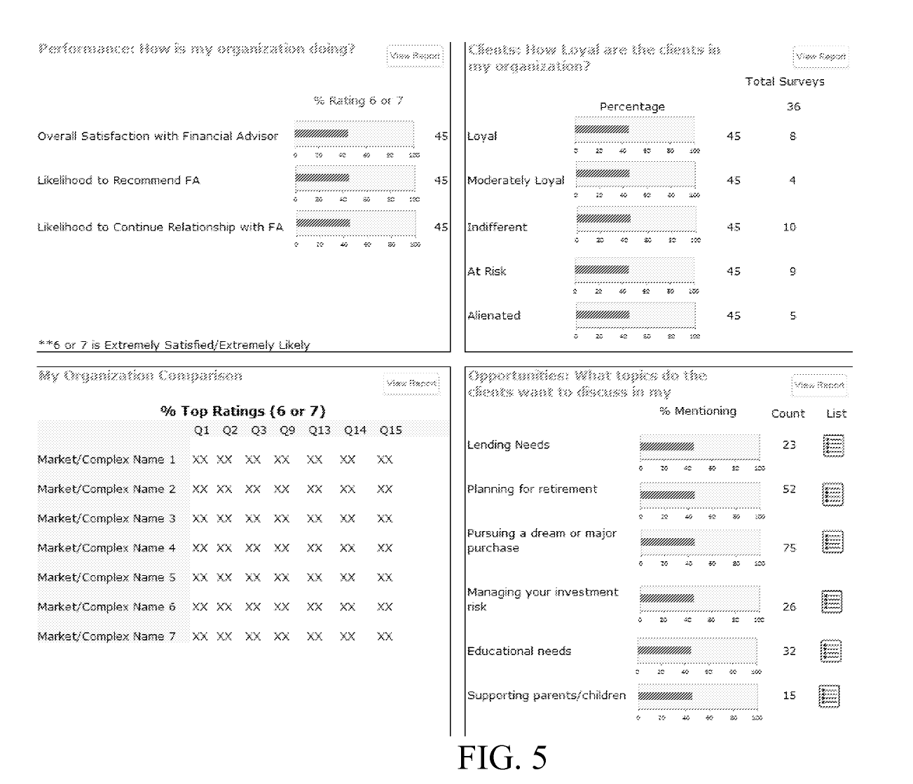

FIG. 5 is a mock-up of a screen shot of an organization dashboard. FIG. 5 parallels FIG. 4 at a broader, organization level. In this form, the dashboard presents four quadrants to the organization summarizing qualitative and quantitative data. The top left quadrant summarizes the quantitative data indicating how the organization is doing. The top right quadrant summarizes the quantitative data indicating how loyal the organization's clients are. The bottom left quadrant summarizes the qualitative data indicating the organization's clients share of the investments as compared to other organizations (complex names). The bottom right quadrant summarizes the quantitative data indicating what topics the organization's clients want to discuss.

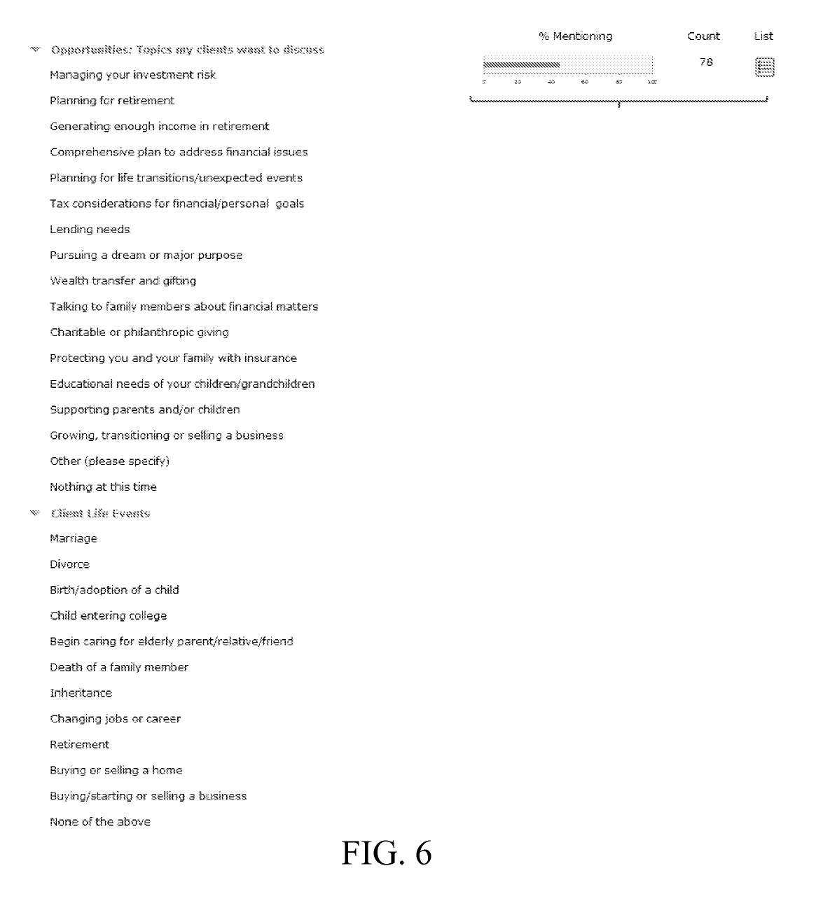

FIG. 6 is a mock-up of a screen shot of an opportunity summary for either a financial advisor or an organization. FIG. 6 opportunities for a financial advisor in discussing the various listed topics with their clients. Only one bar graph indicating the percentage of clients which mentioned “managing your investment risk” is shown. A separate, similar bar graph would be presented in the screen shot for each topic. The count of 78 indicates the total number of clients identified “managing your investment risk” as a topic they would like to discuss with their financial advisor.

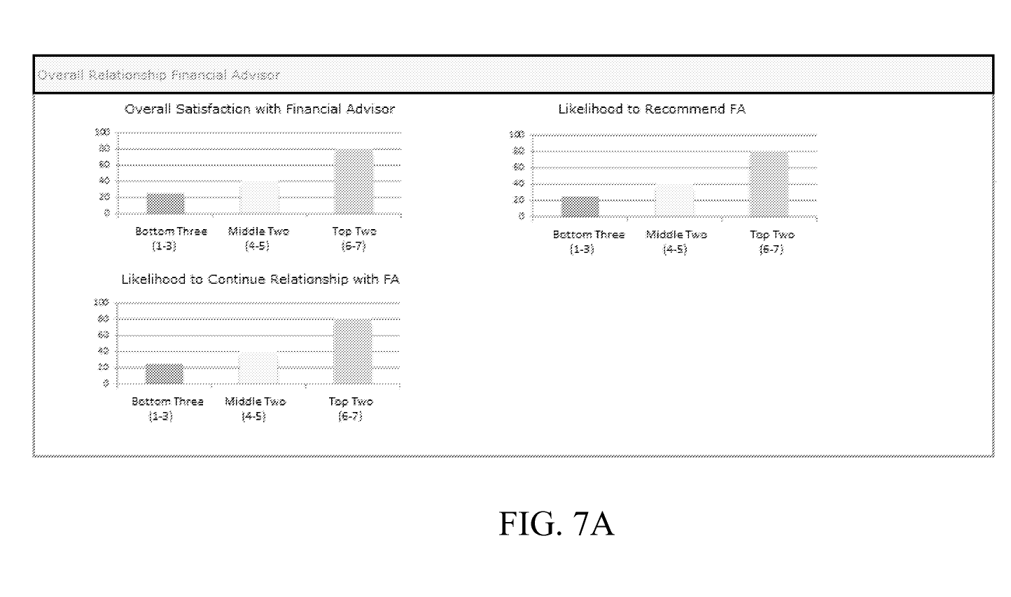

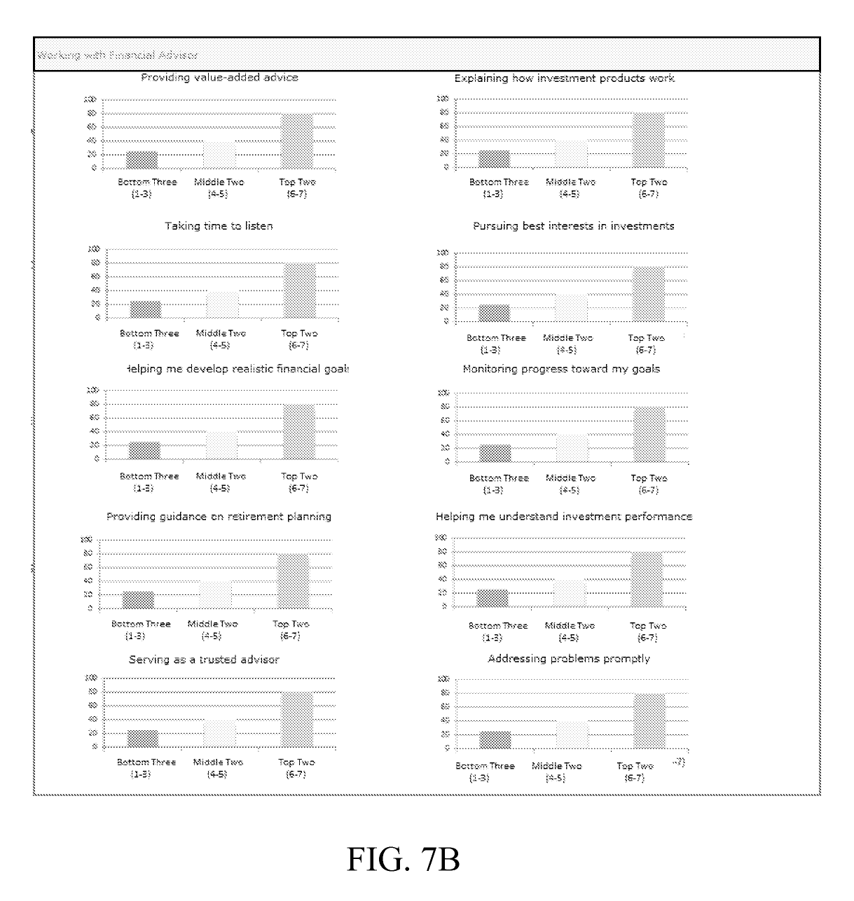

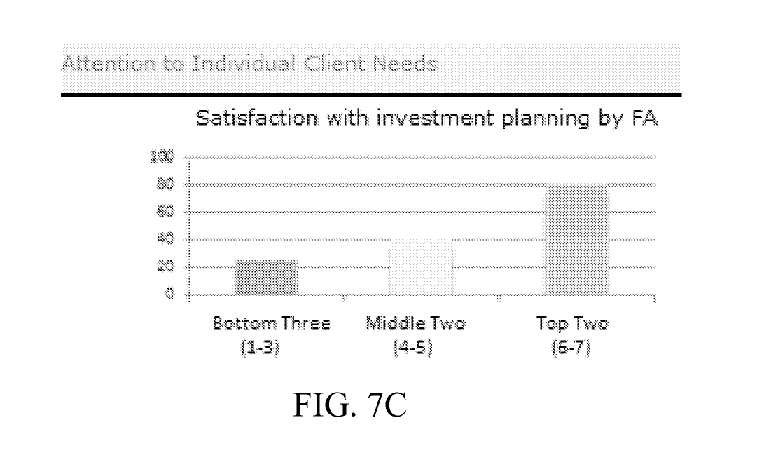

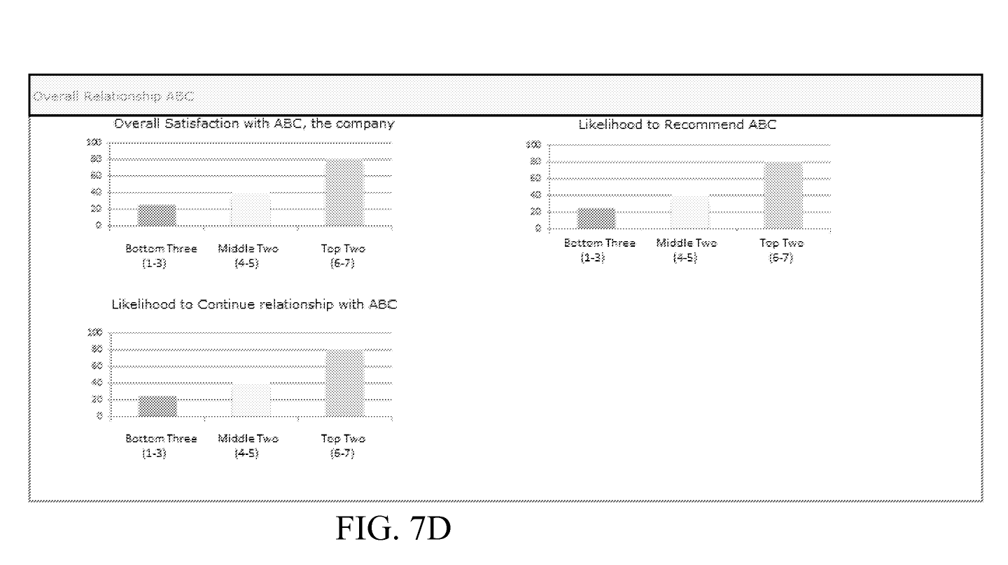

FIGS. 7A-7D are mock-ups of screen shots of responsibility distribution. FIG. 7A provides bar graphs illustrating the overall relationship of a financial advisor to his/her clients, corresponding to the top left quadrant of FIG. 5. FIG. 7B provides bar graphs illustrating the perceptions of a financial advisor of his/her clients within the context of working together. FIG. 7C provides bar graphs illustrating the perceived results of a financial advisor of his/her clients within the context of investment planning FIG. 7D provides bar graphs illustrating the overall relationship of a client to the organization of his/her financial advisor (i.e., the financial advisor is part of ABC company.

Appendix A illustrates a mock-up of a screen shot of survey results of a particular client of his/her financial advisor. A similar screen shot (not shown) can be provided at an organizational level.

Appendix B illustrates a mock-up of a screen shot of survey results of a plurality of clients of their financial advisor. A similar screen shot (not shown) can be provided at an organizational level.

The Abstract and summary are provided to help the reader quickly ascertain the nature of the technical disclosure. They are submitted with the understanding that they will not be used to interpret or limit the scope or meaning of the claims. The summary is provided to introduce a selection of concepts in simplified form that are further described in the Detailed Description. The summary is not intended to identify key features or essential features of the claimed subject matter, nor is it intended to be used as an aid in determining the claimed subject matter.

For purposes of illustration, programs and other executable program components, such as the operating system, are illustrated herein as discrete blocks. It is recognized, however, that such programs and components reside at various times in different storage components of a computing device, and are executed by a data processor(s) of the device.

Although described in connection with an exemplary computing system environment, embodiments of the aspects of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well-known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the invention may be described in the general context of data and/or processor-executable instructions, such as modules, stored one or more tangible, non-transitory storage media and executed by one or more processors or other devices. Generally, modules include, but are not limited to, program modules, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments of the aspects of the invention may be implemented with processor-executable instructions. The processor-executable instructions may be organized into one or more processor-executable components or modules on a tangible processor readable storage medium. Aspects of the invention may be implemented with any number and organization of such components or modules. For example, aspects of the invention are not limited to the specific processor-executable instructions or the specific components or modules illustrated in the figures and described herein. Other embodiments of the aspects of the invention may include different processor-executable instructions or components having more or less functionality than illustrated and described herein.

The order of execution or performance of the operations in embodiments of the aspects of the invention illustrated and described herein is not essential, unless otherwise specified. That is, the operations may be performed in any order, unless otherwise specified, and embodiments of the aspects of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the aspects of the invention are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the aspects of the invention by way of example and not by way of limitation. This description enables one skilled in the art to make and use the aspects of the invention, and describes several embodiments, adaptations, variations, alternatives and uses of the aspects of the invention, including what is presently believed to be the best mode of carrying out the aspects of the invention. Additionally, it is to be understood that the aspects of the invention is not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

Having described aspects of the invention in detail, it will be apparent that modifications and variations are possible without departing from the scope of aspects of the invention as defined in the appended claims. It is contemplated that various changes could be made in the above constructions, products, and methods without departing from the scope of aspects of the invention. In the preceding specification, various preferred embodiments have been described with reference to the accompanying drawings. It will, however, be evident that various modifications and changes may be made thereto, and additional embodiments may be implemented, without departing from the broader scope of the aspects of the invention as set forth in the claims that follow. The specification and drawings are accordingly to be regarded in an illustrative rather than restrictive sense.

What is claimed is:

1. A system for implementing a certification program for individuals comprising:
A design module and interface for defining a certification program for individuals;
An input module and interface for receiving qualitative and quantitative data for each individual wherein the received data corresponds to the defined certification program;
An analytic module with rules of the defined certification program applied to the received data to provide a qualitative analysis of the received qualitative data and to provide a quantitative analysis of the received quantitative data; and
A classification module for classifying and ranking individuals based on the provided analysis wherein selected individuals are certified based on the classification and ranking.

2. The system of claim 1 further comprising a reporting module for presenting the classification and ranking of individuals.

3. The system of claim 2 further comprising a recognition module for awarding certifications and for generating recognition.

4. The system of claim 1 wherein the design module and interface includes:
A module for defining quantitative measurement of each individual;
A module for defining qualitative measurement of each individual;
A module for defining targets each individual; and
A module for defining evaluation parameters and criteria for each individual.

5. The system of claim 1 wherein the design module and interface includes a module for creating a sampling module implementing computer-executable instructions for a sampling plan.

6. The system of claim 1 wherein the input module includes:
A module for sampling qualitative and quantitative data for each individual; and
A module for collecting the sampled data.

7. The system of claim 1 wherein the analytic module includes:
A target setting analysis module for setting a target for each individual;
An individual scoring module for scoring each individual;
A data summarization module for summarizing the received data;
An analysis module for analyzing received data which drives the classification and ranking of the individuals;
A trend module for identifying trends in the received data; and
A subgroup analysis module for analyzing received data based on subgroups of the individuals.

8. The system of claim 1 wherein each module comprises a processor and computer executable instructions executed by its processor for implementing the module or wherein each module comprises computer executable instructions and one or more processors access each module for executing the instructions to implement the modules.

9. A tangible, non-transitory storage medium having processor executable instructions for implementing a certification program for individuals, said instructions comprising:
discovery/design instructions for assisting a program implementer in specifying a scope of quantitative research which will be part of the certification program;
execute instructions which for executing a client survey for measuring individual performance; and
evaluate instructions for analyzing the collected data.

10. The medium of claim 9 further comprising recognize instructions which permit the program implementer and individuals to review program results, award certifications, generate publicity or other external recognition, and generate internal recognition.

11. The medium of claim 9 wherein the evaluate instructions comprise instructions to provide one or more of the following:
identify targets for an individual;
score individuals;
compare individuals to their peers and compare individuals' targets to peer targets;
compile and summarize the qualitative assessment data collected by the execute instructions; and
identify strengths and weaknesses of individuals.

12. The medium of claim 11 further comprising recognize instructions which permit the program implementer and individuals to review program results, award certifications, generate publicity or other external recognition, and generate internal recognition.

13. A computerized method executed by a processor for implementing a certification program for individuals comprising the steps of:
defining a certification program for individuals;
receiving qualitative and quantitative data for each individual wherein the received data corresponds to the defined certification program;
applying rules of the defined certification program to the received qualitative data to provide an analysis of the received qualitative data; and
applying rules of the defined certification program to the received qualitative data to provide an analysis of the received quantitative data; and
classifying and ranking individuals based on the provided analysis of the qualitative data and of the qualitative data;
certifying selected individuals based on the classification and ranking.

14. The method of claim 13 further comprising presenting the classification and ranking of individuals.

15. The method of claim 14 further comprising awarding certifications and generating recognition.

16. The method of claim 13 wherein defining a certification program for individuals includes:
defining quantitative measurement of each individual;
defining qualitative measurement of each individual;
defining targets each individual; and
defining evaluation parameters and criteria for each individual.

17. The method of claim 16 wherein defining a certification program for individuals includes creating a sampling module implementing computer-executable instructions for a sampling plan.

18. The method of claim 16 wherein defining a certification program for individuals includes:
sampling qualitative and quantitative data for each individual; and
collecting the sampled data.

19. The method of claim 13 wherein applying rules includes:
setting a target for each individual;
scoring each individual;
summarizing the received data;
analyzing received data which drives the classification and ranking of the individuals;
identifying trends in the received data; and
analyzing received data based on subgroups of the individuals.

20. The method of claim 13 wherein each step comprises computer executable instructions executed by a processor.
